(19) United States
(12) Patent Application Publication
(10) Pub. No.: US 2015/0052293 A1
(43) Pub. Date: Feb. 19, 2015

(54) HIDDEN CORE TO FETCH DATA

(71) Applicants: Blaine D. Gaither, Fort Collins, CO (US); Russ W. Herrell, Fort Collins, CO (US); Craig Warner, Irving, TX (US)

(72) Inventors: Blaine D. Gaither, Fort Collins, CO (US); Russ W. Herrell, Fort Collins, CO (US); Craig Warner, Irving, TX (US)

(21) Appl. No.: 14/387,598

(22) PCT Filed: Apr. 30, 2012
(86) PCT No.: PCT/US2012/035761

§ 371 Date: Sep. 24, 2014

(51) Int. Cl. G06F 12/08

(52) U.S. Cl. CPC G06F 12/0862; G06F 12/0808; G06F 2212/602; G06F 2212/621; G06F 2212/7201
USPC 711/103; 711/137; 711/135

(57) ABSTRACT

A computing device includes a home node controller to couple a home processor socket to the computing device. The home processor socket includes a home core hidden from the computing device and the home core fetches data to a home cache of the home processor socket. The computing device includes a source processor socket including a source core to request for data and the home node controller forwards requested data from the home cache to the source core if the requested data is included on the home cache.

### BACKGROUND

When a processor requests a computing device for data, the processor can initially check if the data is included in a cache of the processor. If the data is available, a cache hit will have occurred and the data can be retrieved from the cache. If the data is not available, a cache miss will have occurred and the processor can proceed to access a main memory component of the computing device to retrieve the data.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing device with a home node component including a home processor socket according to an example.

FIG. 2 illustrates a hidden home core fetching data onto a home cache and a source core requesting for data according to another example.

FIG. 3A and FIG. 3B illustrate flow diagrams of a source core requesting for data according to examples.

FIG. 4 is a flow diagram of source core writing-back to a memory component according to an example.

FIG. 5 is a flow diagram of a home core executing a setup for data to be forwarded from a home cache according to another example.

FIG. 6 is a flow chart for managing data according to an embodiment.

FIG. 7 is a flow chart for managing data according to another embodiment.

### DETAILED DESCRIPTION

A computing device can include one or more node components with a node controller and processor sockets. For the purposes of this application, a node component is a hardware component of the computing device, such as an expansion card, which can couple one or more processor sockets included on the node component to the computing device. A processor socket is a computing component which includes a cache and one or more processor cores. A processor core can read and execute data and/or instructions from one or more components of the computing device. A node controller manages and controls access to the processor sockets included on the node component.

One of the node components can be a home node component including a home processor socket with a home core which is hidden from one or more components of the computing device. In one embodiment, the home core can be hidden by the home controller through a firmware of the computing device. As the home core remains hidden, the home core fetches data from a memory component to reside on the home cache of the home processor socket. The memory component can include random access memory and/or any additional volatile or non-volatile memory of the computing device. By using the home core to fetch data onto the home cache, another processor core of the computing device, such as a source core, can request for the data residing on the cache and the data can ha forwarded to the requesting source core.

For the purposes of this application, a source core is a processor core which issues a request for data. The source core can be included on a source processor socket couple to a source node component of the computing device. In one embodiment, when requesting for data, the source core specifies which address of a cache, the data resides in. A source controller coupled to the source processor socket transmits a request for the data to the home controller on the home processor socket. If the requested data is included in the home cache, the requested data can be forwarded to the source core by the home controller.

In one embodiment, the home controller can issue the request for data to a home agent of the processor socket. For the purposes of this application, the home agent is a hardware and/or software module which owns and manages the data residing on the home cache. The home agent issues a snooping request at the requested address of the home cache to transition the data residing at the requested address to a modified state. The data corresponding to the requested address is forwarded back to the source core as requested data. As a result, the home cache of the home processor socket can be utilized to receive and store data to be requested by a source core. Further, by providing the requested data from the home cache as opposed to a memory component, bandwidth, time, and/or resources can be saved as the computing device provides the source core the requested the data.

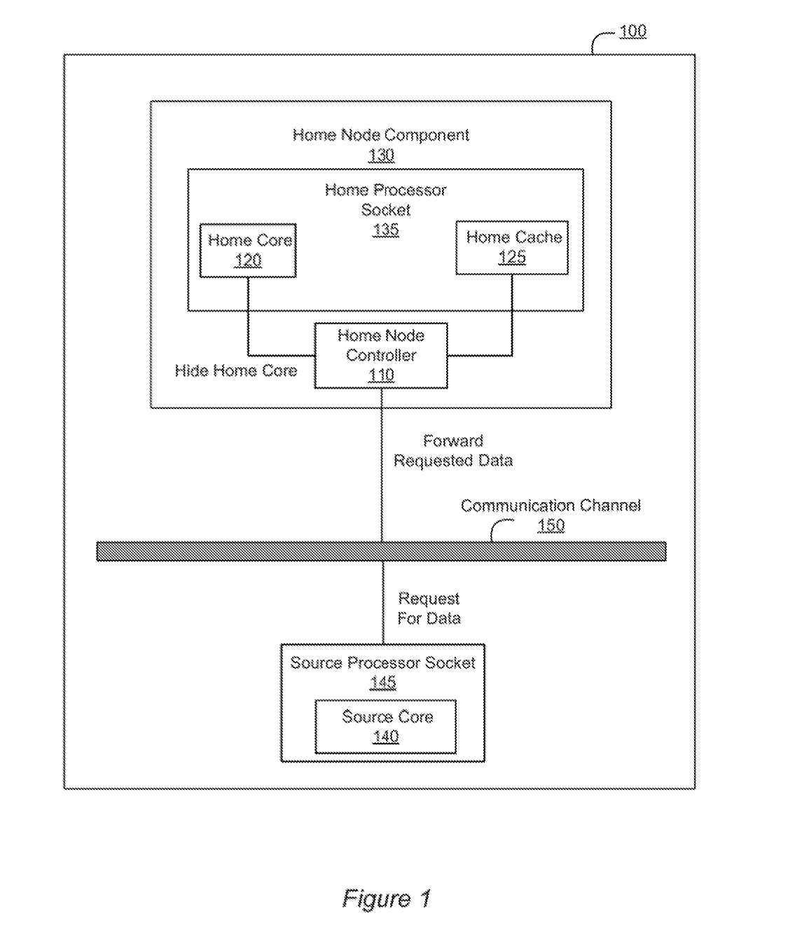

FIG. 1 illustrates a computing device 100 with a home node component 130 including a home processor socket 135 according to an example. The computing device 100 can be a laptop, a notebook, a tablet, a netbook, an all-in-one system, a desktop, a workstation, and/or a server. In another embodiment, the computing device can be a cellular device, a PDA (Personal Digital Assistant), and/or an E (Electronic)-Reader and/or any additional computing device with a home node component 130. As shown in FIG. 1, the computing device 100 includes a home node component 130 with a home processor socket 135 and a home node controller 110.

For the purposes of this application, the home node component 130 is an expansion module of the computing device 100 which includes at least one processor socket, such as the home processor socket 135 and a home node controller 110. The home processor socket 135 is a computing component which includes a home core 120 and a home cache 125. The home core 120 is a processor core which is hidden from components of the computing device 100 by the home node controller 110. The home node controller 110 is a hardware component which manages processor sockets included on the home node component 130.

The home node controller 110 can utilize a firmware residing on the home node controller 110, the home processor socket 135, the home node component 130, and/or on the computing device 100 to hide the home core 120 from other components of the computing device 100. In one embodiment, the home node controller 110 can utilize the firmware to mask the home core 120 such that it is not visible or appears disabled to other components of the computing device 100. In another embodiment, the home node controller 110 can use the firmware to access a basic input/output system of the computing device 100 to hide the home core 120.

The home node controller 110 can also manage communication between the home processor socket 135 and another processor socket of the computing device 100, such as a source processor socket 145. Similar to the home processor socket 135, the source processor socket 145 is a computing component which includes one or more processor cores, such as a source core 140. In one embodiment, the source processor socket 145 resides on a separate node component of the computing device 100, such as a source node component. The home node component 130 is coupled to source node component through a communication channel 150. The communication channel 150 can be a communication bus or interface to for the node components to communicate with one another.

As the home core 120 is hidden from components of the computing device 100, the home core 120 can fetch data onto a home cache 125 of the home processor socket 135 from a memory component. For the purposes of this application, the home cache 120 is a memory bank which is coupled to the home core 120 and the memory component. In one embodiment, the home cache 125 includes a lower level cache of the home processor socket 135. The memory component can be random access memory residing on the home node component 130 and/or on the computing device 100. The memory component can include data to be fetched onto the home cache 125. In one embodiment, the data can include lines of code or instructions which can be executed by the source core 140 or another processing core.

As the home core 120 continues to fetch data onto the home cache 125, the home node controller 110 can detect for a request for data. The request for data can be received from the source core 140 on the source processor socket 145. The source core 140 is a processor core included on the source processor socket 145 which can request for data. The request can be sent by the source core 140 as an instruction and/or as a signal to the home node controller 110. In one embodiment, the request for data can specify an address of the home cache 125 where the data is expected to be included.

In response to receiving the request for data, the home node controller 110 can determine whether any data resides at the address of the home cache 125 specified by the request for data. If any data is included at the requested address of the home cache 125, the home node controller 110 can proceed to forward the requested data from the home cache 125 to the source core 140. As a result, by utilizing the home core 120 to fetch data to be stored on the home cache 125, data requested by a source core 140 can be forwarded from the home cache 125 as opposed to a main memory component of the computing device 100 thereby saving bandwidth, time, and/or resources.

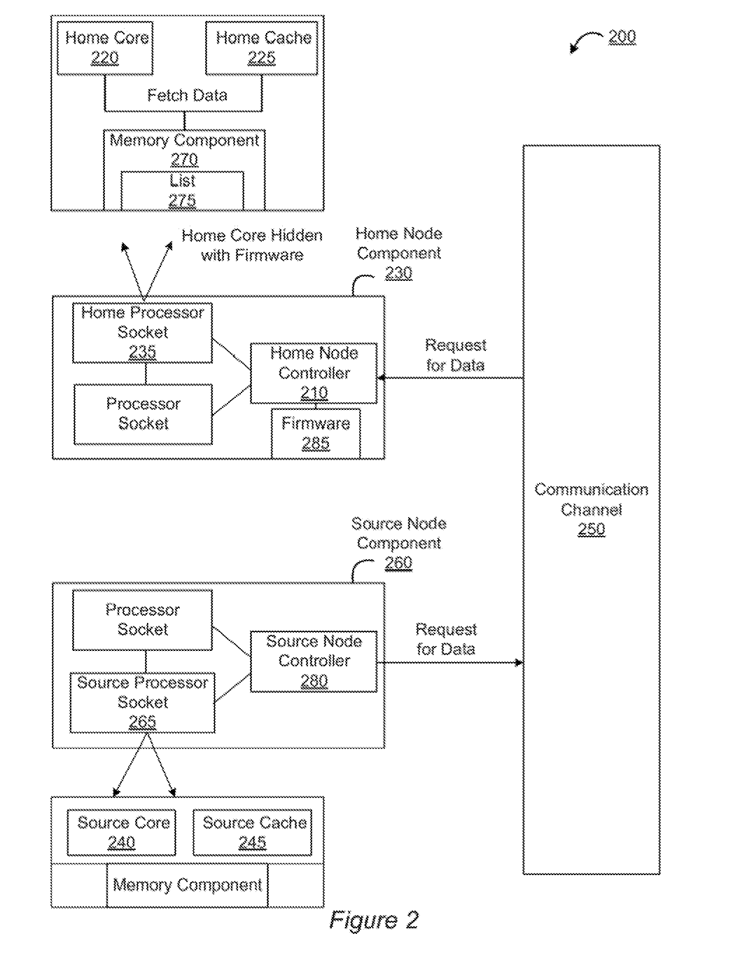

FIG. 2 illustrates a hidden home core 220 fetching data onto a home cache 225 and a source core 240 requesting for data according to another example. The home core 220 resides on a home processor socket 235 included on a home node component 230. In one embodiment, as shown in FIG. 2, the home node component 230 can include more then one processor socket. Each processor socket can include one or more processor cores coupled to corresponding caches. In one embodiment, more than one processor core included on the home processor socket 235 or another processor socket can be hidden from components of the computing device 200.

When hiding a processor core, such as the home core 220, a home node controller 210 included on the home node component 230 can use an accessible firmware 285 to hide the home core 220. As noted above, the home node controller 210 is a hardware component which manages the home processor socket 235 by hiding the home core 220. For the purposes of this application, the firmware 385 includes software and/or instructions executable by the home node controller 210 to hide the home core 220. The firmware 385 can be included on the home node controller 210, the home node component 230, the home processor socket 235, and/or on another component of the computing device 200.

In one embodiment, the home node controller 210 can use the firmware 285 to mask the home core 220 such as that it appears invisible or disabled to other components of the computing device 200. In another embodiment, the home node controller 210 can use the firmware to modify a BIOS (Basic Input/Output System) of the computing device 200, such that the home core 220 is not accessible to other components of the computing device 200. In other embodiment, the home node controller 210 can use additional methods to hide the home core 220 in addition to and/or in lieu of those noted above.

As the home core 220 remains hidden, the home core 220 can fetch data onto the home cache 225 from a memory component 270. As noted above, the home cache 225 is a memory bank coupled to the home core 220 and a memory component 270. In one embodiment, the home cache 225 includes a lower level cache of the home processor socket 235. The memory component 270 can include random access memory and/or any additional memory included on the home node component 230 or the computing device 200. The data included on the memory component 270 can include lines of executable code which may be requested by a core induced on the home node component 230 and/or by another core included on another node component.

In one embodiment, as shown in FIG. 2, the memory component 270 can include a list 275. The list 275 can specify which lines of data or code of the memory component 270 the home core 220 is to fetch onto the home cache 225. The list 275 can be stored on the memory component 270 as a file, a table, and/or any additional list which can specify lines of data or code to fetch. As data is fetched onto the home cache 225 by the home core 220, the home node controller 210 can update the list 275 to include new lines of code or data for the home core 220 to fetch onto the home cache 225.

The home node controller 210 can also detect for a request for data from another node controller coupled to the computing device. The request for the data can be initiated by a source core 240 and can be sent as a signal and/or instruction from the source core 240. As noted above, the request for data can specify an address of a cache which the source core 240 presumes the requested data is present in. As shown in FIG. 2, the source core 240 is included on a source processor socket 285 on a source node component 260. Similar to the home node component 230, the source node component 260 includes a source node controller 280 and one or more processor sockets with corresponding processing cores. The source node controller 280 manages the processor sockets included on the source node controller 280 and interfaces the processor sockets with the computing device 200.

As the source core 240 issues the request for data, the source node controller 280 receives the request from the source processor socket 265 and proceeds to forward the request to the home node component 230 through the communication channel 250. If the computing device 200 includes additional node components, the request for data can be sent to the additional node components through the communication channel 280. In response to receiving the request for data, the home node controller 210 can forward the requested data if the home cache 225 includes the requested data.

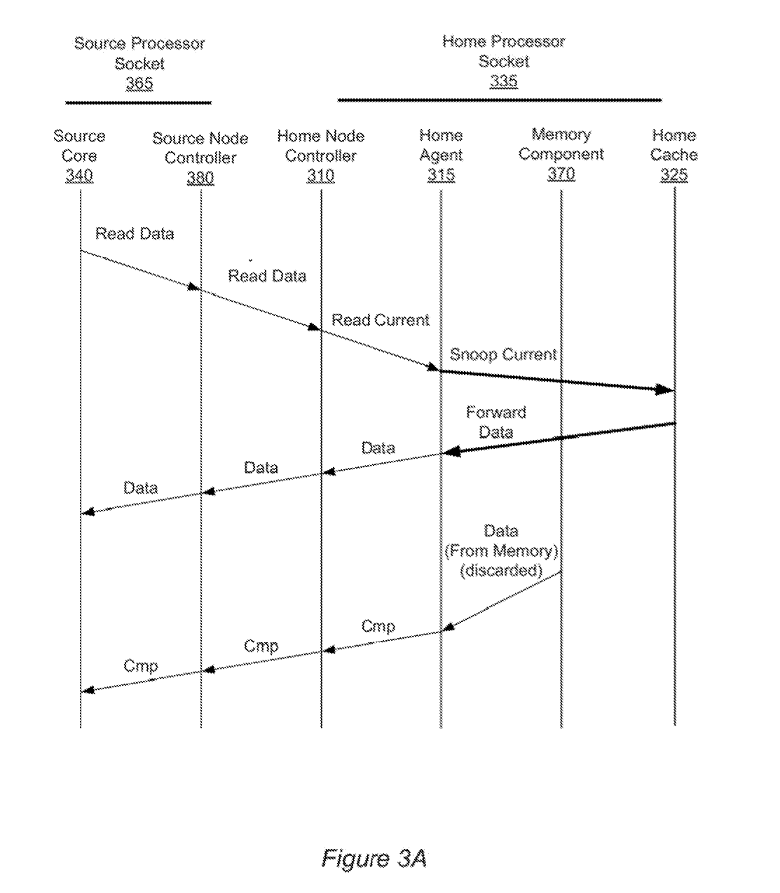

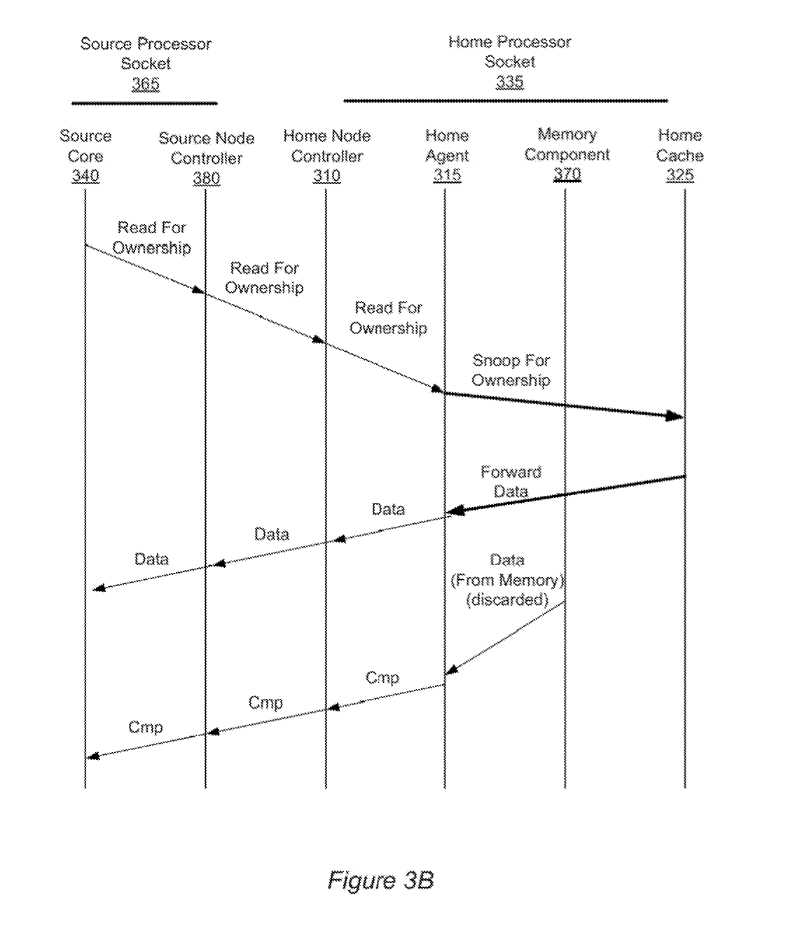

FIG. 3A and FIG. 3B illustrate flow diagrams of a source core 340 requesting for data according to examples. As shown in FIG. 3A, when issuing a request for data, the source core 340 can issue a Read Data request. The Read Data request is an instruction by the source core 340 to read the contents of a cache. The Read Data request can specify an address of a cache where the requested data is expected to reside at. The Read Data request can be received by the source node controller 380 and can be forwarded through a communication channel to the home node controller 310. In another embodiment, the source core 340 can issue a Read Code request which can be forwarded by the source node controller 380.

In response to receiving the Read Data request or the Read Code request, the home node controller 310 can issue a Read Current request to a home agent 315 of the home processor socket 335. The Read Current request is an instruction from the home node controller 310 to react the current contents of the cache at a specified address. For the purposes of this application, the home agent 315 is a hardware or software module which manages data included on the home cache 325. In response to receiving the Read Current request from the home node controller 310, the home agent 315 proceeds to issue a Snoop Current request to the home cache 325. The Snoop Current request is an instruction to look for data residing at the specified address of the home cache 325.

By issuing the Snoop Current request to the specified address, any data included at the specified address remains or transitions to a modified state. If the data at the specified address is already in the modified state, the data remains in the modified state. If the data is not in the modified state, the data transitions to the modified state. For the purposes of this application, if any data of the home cache 325 is in a modified state, the corresponding data is forwarded from the home cache 325 as requested data. If the specified address of the home cache 325 includes any data, the home agent 315 determines that the requested data is found. The requested data is then forwarded from the home cache 325 to the home agent 315. The requested data is then forwarded to the home controller 310, which forwards the requested data to the source node controller 380. The source node controller 380 then provides the requested data to the source core 340.

In one embodiment, if the specified address of the home cache 325 does not include any data, an Invalid Snoop Response is generated indicating that a cache miss has occurred. In response to a cache miss, the home agent 315 issues a Memory Read request to the memory component 370 for the requested data. If the requested data is included in the memory component 370, the requested data is discarded from the memory component 370 and is sent to the source core 340 through the home agent 315, home node controller 310, and the source node controller 380.

In another embodiment, as shown in FIG. 3B, instead of issuing a Read Data request or a Read Code request, the source core 340 can issue a Read for Ownership request. The Read for Ownership request is an instruction for the source core 340 to both read the contents at a specified address and also to transition any data residing at the address to an invalid state. The source node controller 380 can receive the Read for Ownership request and forward the request to the home node controller 310. The home node controller 310 can then forward the Read for Ownership request to the home agent 315.

In response to receiving the Read for Ownership request, the Home Agent issues a Snoop for Ownership request to the home cache 325. For the purposes of this application, the Snoop for Ownership request from the home agent 315 causes any data residing at the specified address of the home cache 325 to transition to an invalid state. For the purposes of this application, if the data included within the home cache 325 is in an invalid state, the requested data is forwarded from the home cache 325 to the home agent 313. The home agent 315 then forwards the requested data to the home node controller 310 to provide for the source node controller 380. The source node controller 380 can then provide the requested data to the source core 340.

Similar to above, if the specified address of the home cache 325 does not include any data, an Invalid Snoop Response is generated indicating that a cache miss has occurred and the home agent 315 issues a Memory Read request to the memory component 370 for the requested data. If the requested data is included in the memory component 370, the requested data is discarded from the memory component 370 and is sent to the source core 340 through the home agent 315, home node controller 310, and the source node controller 380.

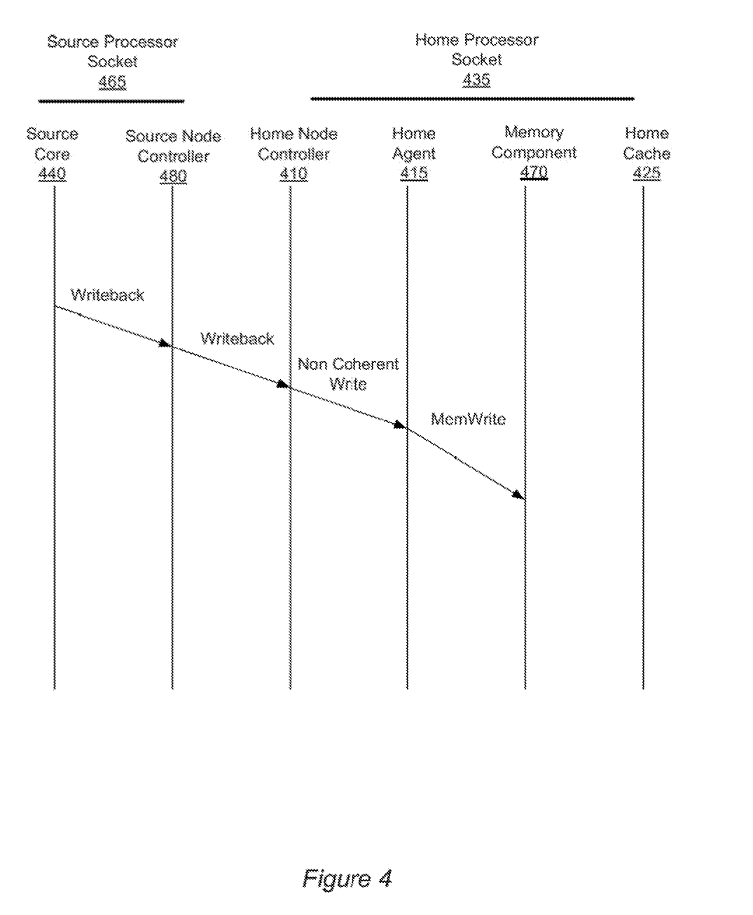

FIG. 4 is a flow diagram of a source core 440 writing data back to a memory component 470 according to an example. As the source core 440 receives requested data from the home cache 425, the source core 440 can retain and/or modify the requested data in a source cache coupled to the source core 440. If the source cache reaches capacity, data included on the source cache is evicted and written-back to the memory component by the source core 440. The source cache is at capacity if the source cache is full and cannot store additional data without discarding existing data on the source cache.

When writing-back to the memory component 470, the source core 440 can issue a write-back instruction of the evicted data to the source node controller 480. The write-back instruction is an instruction for the evicted data on the source cache to be written back into the memory component 370. The write-back instruction can be forwarded to the home node controller 410. The home node controller 410 can then issue a non-coherent write instruction to the home agent 415. In response to receiving the non-coherent write instruction, the home agent 415 proceeds to write the evicted data to the memory component 470. By issuing the non-coherent write instruction, the home agent 415 can properly determine that the data to be evicted is to be written to the memory component 370 as opposed to another cache or be retained on the home cache 425.

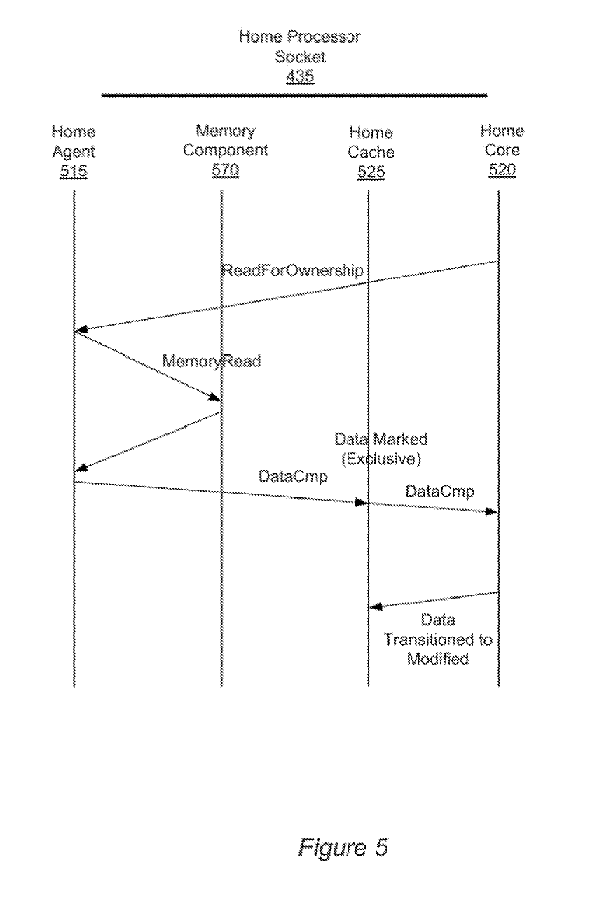

FIG. 5 is a flow diagram of a home core 520 executing a setup for data to be forwarded from a home cache 525 according to another example. As the home core 520 remains hidden, the home core 520 prepares the home agent 515 and home cache 525 to receive Read Data requests. Read Code requests, and/or Read for Ownership requests so that any requested data can properly be forwarded back to the source core. In one embodiment, as shown in FIG. 5, the home core 520 initially issues a Read for Ownership request to the home agent 515. The home agent 515 then reads data from the memory component 570 and forwards the data onto the home cache 525. The home agent 515 marks the data on the home cache 525 as exclusive. The home core 520 then transitions the data on the home cache 525 to a modified state such that it can be forwarded.

In one embodiment, the home core 520 can execute the setup in response the home node component hiding the home core 520 and before any data is fetched onto the home cache 525. In another embodiment, the home core 520 can execute this setup each time after data is forwarded from the home cache 525 to a source core. In other embodiments, the home core 520 can execute additional requests and/or instructions for data to be forwarded from the home cache 525 in addition to and/or in lieu of those noted above and illustrated in FIG. 5.

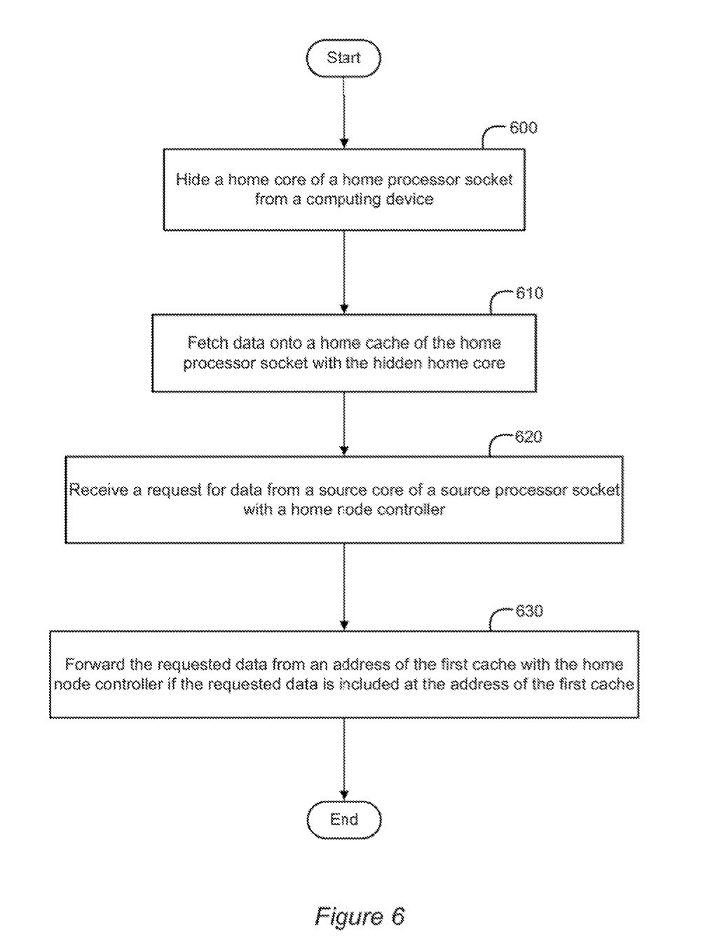

FIG. 6 is a flow chart for managing data according to an embodiment. As noted above, the computing device includes a home node controller with a home node controller and at least one processor socket. One of the processor sockets is a home processor socket. The home node controller hides a home core of a home processor socket from components of the computing device with a firmware at 600. As the home core remains hidden, the home core fetches data onto a home cache of the home processor socket at 610. The home node controller can access a list residing on a memory component to identify which data and/or lines of code to fetch from the memory component onto the home cache. As data is fetched, the home node controller can receive a request for data from a source core of a source processor socket at 620. If the requested data is included in the address of the home cache, the home node controller forwards the requested data from an address of the home cache to the source core at 630. The method is then complete. In other embodiments, the method of FIG. 6 includes additional steps in addition to and/or in lieu of those depicted in FIG. 6.

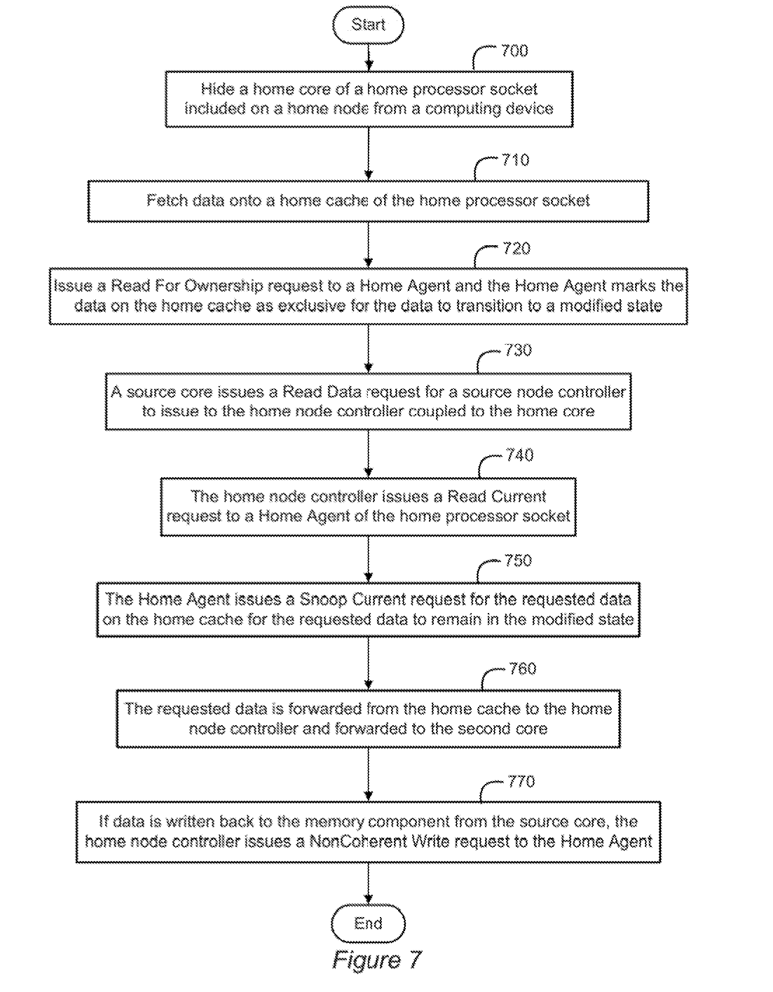

FIG. 7 is a flow chart for managing data according to another embodiment. The home node controller can initially hide a home core from components of the computing device with firmware at 700. As the home core remains hidden, the home core fetches data onto the home cache included on the home processor socket at 710. In one embodiment, the home core also executes a setup to prepare the home agent and home cache to receive Read Data, Read Code, and/or Read for Ownership requests. The home core can issue a Read for Ownership request to the home agent, the home agent can read data on the memory component and include the data on the home cache as exclusive data, the home core can then transition the data on the home cache to a modified state at 720. As data is fetched on the home cache, a source core on a source processor socket can issue a Read Data request for a source node controller to forward to the home node controller at 730.

The home node controller can then issue a Read Current request to the home agent at 740. The Read Current requests causes the home agent to issue a Snoop Current request at a specified address of the home cache for the data at the specified address to remain in the modified state at 750. Because the requested data is in the modified state, the requested data is forwarded to the home node controller and subsequently to the source core at 760. In one embodiment, as the source core continues to receive requested data, the requested data can be stored and/or modified on a source cache coupled to the source core. If the source cache, reaches capacity, the data on the source cache is evicted and the source cache writes the data back to the memory component. The home node controller receives the write back instruction and proceeds to issue a non-coherent write request to the home agent at 770. The method is then complete. In other embodiments, the method of FIG. 7 includes additional steps in addition to and/or in lieu of those depleted in FIG. 7.

What is claimed is:

1. A computing device comprising:
a home node component including a home node controller to couple a home processor socket to the computing device;
wherein the home processor socket includes a home core hidden from the computing device and the home core fetches data to a home cache of the home processor socket;
a source processor socket including a source core to request for data; and
wherein the home node controller forwards requested data from the home cache to the source core if the requested data is included on the home cache.

2. The computing device of claim 1 wherein the request for data specifies an address of a cache and the requested data forwarded by the home node controller includes data residing at the address on the home cache.

3. The computing device of claim 1 wherein the source processor socket is included on a source node component of the computing device with a source node controller.

4. The computing device of claim 1 wherein the home core is hidden to the computing device with firmware.

5. The computing device of claim 1 wherein the home core executes a setup such that the home cache can respond to receiving a Read Data request or a Request for Ownership request.

6. The computing device of claim 1 further comprising a memory component to include a list indicating which lines from the memory component for the home core to fetch as data.

7. A method for managing data comprising:
hiding a home core of a home processor socket from a computing device;
fetching data onto a home cache of the home processor socket with the hidden home core;
receiving a request for data from a source core of a source processor socket with a home node controller; and
forwarding the requested data from an address of the first cache with the home node controller if the requested data is included at the address of the first cache.

8. The method for managing data of claim 7 wherein the source core issues a Read Data request for a source node controller to issue to the home node controller coupled to the home core.

9. The method for managing data of claim 8 wherein the home node controller issues a Read Current request to a Home Agent of the home processor socket.

10. The method for managing data of claim 9 wherein the Home Agent issues a Snoop Current request for a requested address on the home cache for the requested data at the address to transition to a modified state.

11. The method for managing data of claim 7 further comprising evicting the requested data from the home cache if the home cache is at capacity and the requested data is written back to e memory component with a Write Back instruction.

12. The method for managing data of claim 11 wherein the home node controller issues a Non Coherent Write request to the Home Agent if the matching data is evicted from the home cache.

13. A computing device comprising:
a home node component including a home node controller to couple a home processor socket to the computing device;
wherein the home processor socket includes a home core hidden from the computing device through firmware and the home core fetches data to a home cache of the home processor socket;
a source node component including a source node controller receive a request for data from a source processor socket including a source core; and
wherein the requested data from the home cache of the home processor socket is forwarded by the home node controller to the source core if the requested data is included at an address of the home cache requested by the source core.

14. The non-volatile computer readable medium of claim 13 wherein source home core issues a Request For Ownership which is transmitted to the home agent by the source node controller.

15. The non-volatile computer readable medium of claim 14 wherein the home agent issues a Snoop for Ownership request for a requested address on the home cache to transition to an invalid state such that the requested data residing on the requested address is forwarded to the source core.
